(19) United States
(12) Patent Application Publication
(10) Pub. No.: US 2005/0154603 A1
(43) Pub. Date: Jul. 14, 2005

(54) System for determining compatibility

(76) Inventors: John Daly Adams, La Crescenta, CA (US); Eileen Elizabeth Adams, La Crescenta, CA (US)

Correspondence Address: SHELDON & MAK, INC, 225 SOUTH LAKE AVENUE, 9TH FLOOR, PASADENA, CA, 91101, US

(21) Appl. No.: 10/755,153

(22) Filed: Jan. 9, 2004

(51) Int. Cl. G06F 17/60

(52) U.S. Cl. 705/1

(57) ABSTRACT

A method for determining compatibility between two people comprises asking a first person a plurality of questions; receiving from the first person a plurality of responses to the questions; asking a second person the plurality of questions; receiving from the second person a plurality of responses to the questions; comparing the responses received from the first person and the responses received from the second person to determine the compatibility of the first person and the second person; and reporting the determination to at least one of the persons without revealing at least one of the compared answers received.

### BACKGROUND

The present invention is directed to a system and method for allowing a person to determine whether they are compatible with another person.

Presently, a large percentage of marriages end in failure in the United States. It is believed that many of these marriages fail because the two people are incompatible.

Compatible feelings and attitudes about relationships and sex is usually necessary for long term relationship success. Presently, in order to ascertain whether there is compatibility, the members of a couple have to reveal their attitudes and feelings to each other about specific intimate topics, such as sexual acts. However, people are often uncomfortable speaking directly about intimate topics. Further, the necessity of having to reveal specific intimate attitudes and feelings in order to assess similarity, often prevents assessment of compatibility.

Thus, there is a need for an improved system and method for determining the compatibility of two people that improves upon the shortcomings of the prior art.

### SUMMARY

Accordingly, the present invention is directed to a computerized method for determining compatibility between two people. According to an embodiment of the present invention, the method comprises the steps of: asking a first person a plurality of questions; receiving from the first person a plurality of responses to the questions; asking a second person the plurality of questions; receiving from the second person a plurality of responses to the questions. The method also comprises the steps of comparing the responses received from the first person and the second person; and reporting whether one of the first person or the second person is compatible with the other person without revealing any of the responses received.

Optionally, the plurality of questions has a first set of questions about at least one of sexual attitudes, tolerances and lifestyle. The responses of the first person and the responses of the second person to the first set of questions must be complementary for compatibility.

Optionally, the plurality of questions has a second set of questions about at least one of relationship aspects, sexual activities, and sexual interests. For each question, the user is prompted to select from a range of preference levels. The preference levels may include at least five discreet preference levels substantially corresponding to “must have”, “preferred”, “interested”, “not interested”, and “must not have”.

Optionally, all of the questions answered by the first person as “must have”, must be answered by the second person as “must have” or “preferred” for compatibility. Optionally, all of the questions answered by one of the first person or the second person as “must not have”, must be answered by the other person as “must not have” or “not interested” for compatibility. Additionally, all of the questions answered by one of the first person or the second person as “preferred”, “interested”, and “not interested” are compared to the answers of the other person to obtain a percentage of similarity.

The present invention is also directed to a system for determining compatibility between two people. According to an embodiment, the system comprises: at least one software interface for entering a first profile for a first user and a second profile for a second user; at least one database for storing the first profile and the second profile; and a software program for comparing the profile of the first user and the profile of the second user, and for reporting the compatibility of the first user and the second user without revealing the contents of either the first profile or the second profile.

The present invention is also directed to an online compatibility determining method comprising the steps of: prompting a first user to enter a first profile and second user to enter a second profile. Each profile contains a first set of information describing at least one of sexual attitudes, tolerances and lifestyle and a second set of information describing elements of at least one of relationship aspects, sexual activities, and sexual interests on a range of preference levels.

The online method further includes the steps of receiving from the first user a request to compare the first personal profile with the second personal profile; and comparing the first profile and the second profile to determine compatibility. Compatibility information is then reported to the first user without revealing the contents of either the first profile or the second profile.

### DRAWINGS

A better understanding of the present invention will be had with reference to the accompanying drawings in which:

FIG. 1 is a schematic diagram of a system embodying features of the present invention;

FIG. 2 is a schematic diagram of a computer useable in the system of FIG. 1;

FIG. 3 is a flowchart illustrating a general overview of the method of the present invention according to an embodiment;

FIG. 4 is a flowchart illustrating the process of comparing a requestor's profile with another profile according to an embodiment of the present invention; and

FIG. 5 is a sample compatibility report according to an embodiment of the present invention.

### DETAILED DESCRIPTION

Reference will now be made in detail to exemplary embodiments of the present invention that are illustrated in the accompanying drawings. Wherever possible, the same reference numbers will be used throughout the drawings to refer to the same or like parts.

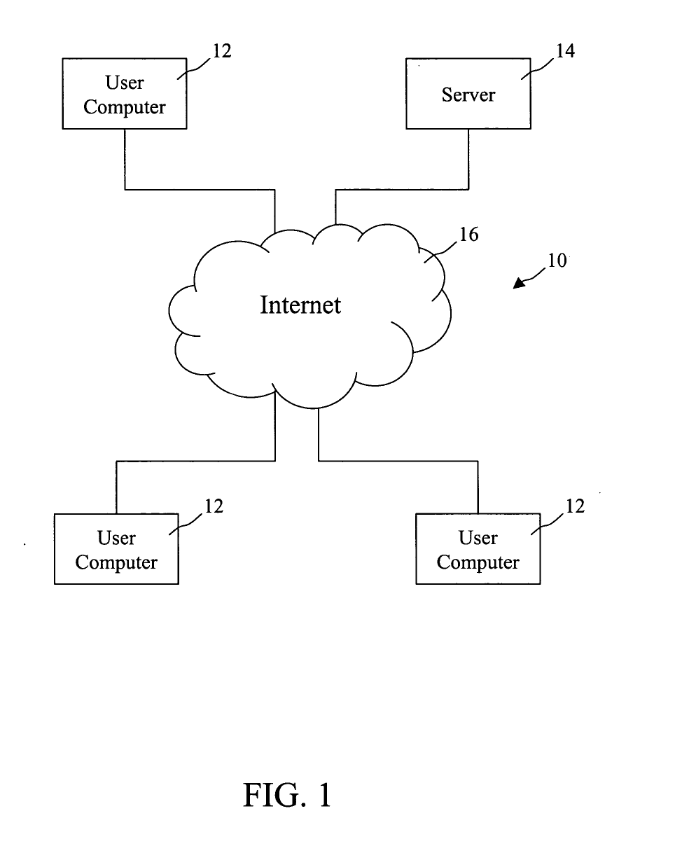

FIG. 1 shows a system for determining compatibility according to an embodiment of the present invention. As shown in FIG. 1, user computer systems 12 are connected to a server computer system 14, or group of computer systems, via the world wide web 16.

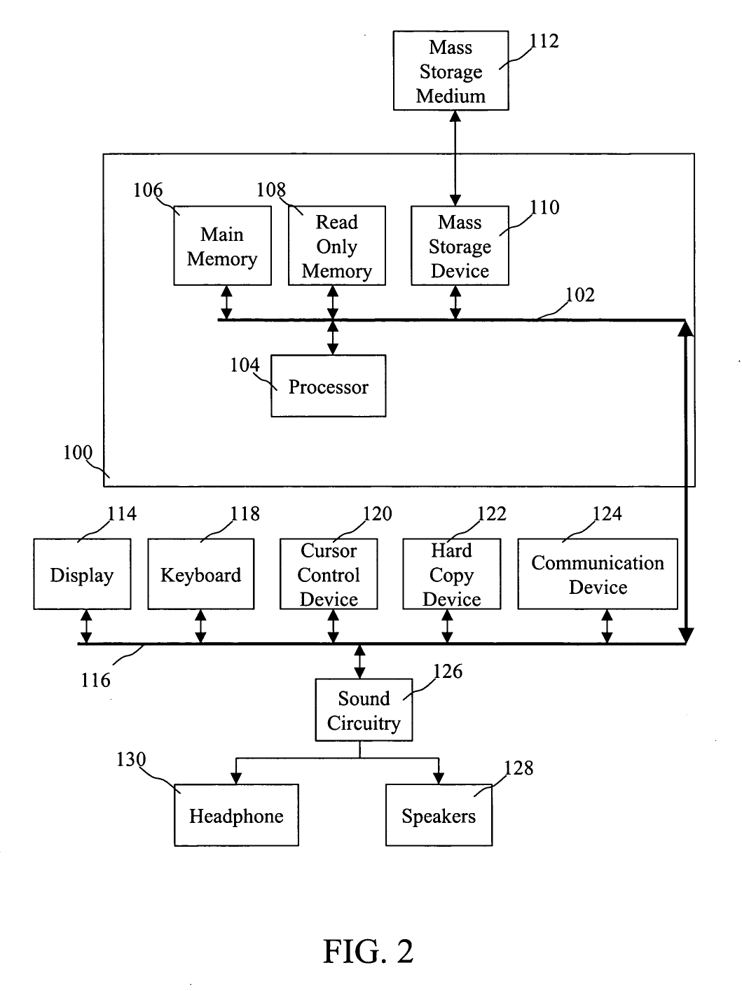

A computer system 100 usable as a user computer system 12 or a server computer system 14 is shown in FIG. 2. It will be apparent to those of ordinary skill in the art, however that additional system architectures may also be used. The computer system 100 illustrated in FIG. 2 includes a bus or other internal communication means 102 for communicating information, and a processor 104 coupled to the bus 102 for processing information.

The system further comprises a random access memory (RAM) or other volatile storage device 106 (referred to as main memory), coupled to bus 102 for storing information and instructions to be executed by the processor 104. The main memory 106 also may be used for storing temporary variables or other intermediate information during execution of instructions by the processor 104. The system also comprises a read only memory (ROM) and/or static storage device 108 coupled to bus 102 for storing static information and instructions for the processor 104, and a mass storage device 110 such as a magnetic disk drive or optical disk drive. The mass storage device 110 is coupled to bus 102 and is typically used with a computer readable mass storage medium 112, such as a magnetic or optical disk, for storage of information and instructions.

The system may further be coupled to a display device 114, such as a cathode ray tube (CRT) or a liquid crystal display (LCD) coupled to bus 102 through bus 116 for displaying information to a computer user. An alphanumeric input device 118, including alphanumeric and other keys, may also be coupled to bus 102 through bus 116 for communicating information and command selections to the processor 104. An additional user input device is a cursor control 120, such as a mouse, a trackball, stylus, or cursor direction keys coupled to bus 102 through bus 116 for communicating direction information and command selections to the processor 104, and for controlling cursor movement on the display device 114.

Another device which may optionally be coupled to bus 102 through bus 116 is a hard copy device 122 which may be used for printing instructions, data, or other information on a medium such as paper, film, or similar types of media. Optionally, a communication device 124 is coupled to bus 102 through bus 116 for use in accessing other nodes of a network computer system or other computer peripherals. The communication device 124 may include any of a number of commercially available networking peripheral devices such as those used for coupling to an Ethernet, token ring, Internet, or wide area network.

The communication device 124 may also include any number of commercially available peripheral devices designed to communicate with remote computer peripherals such as scanners, terminals, specialized printers, or audio input/output devices. The communication device 124 may also include an RS232 or other conventional serial port, a conventional parallel port, a small computer system interface (SCSI) port or other data communication means. The communications device 125 may use a wireless means of data transfer devices such as the infrared IRDA protocol, spread-spectrum, or wireless LAN.

The system may also have sound circuitry 126 either with attached speakers 128 or headphones 130, or with analog audio outputs suitable for input into audio reproduction equipment such as external amplifiers and speakers, cassette adapters, etc. Sound circuitry 126 is well known in the art for playing audio files.

Note that any or all of the components of the system illustrated in FIG. 2 and associated hardware may be used in various embodiments of the present invention; however, it will be appreciated by those of ordinary skill in the art that any configuration of the system may be used for various purposes according to the particular implementation. In one embodiment of the present invention, the system illustrated in FIG. 2 is an IBM® compatible personal computer (PC), an Apple MacIntosh® personal computer, or a SUN® SPARC Workstation. The processor 104 may be one of the 80X86 compatible microprocessors such as the 80486 or PENTIUM® brand microprocessors manufactured by INTEL® Corporation of Santa Clara, Calif.

The software implementing the present invention can be stored in main memory 106, mass storage device 110, or another storage medium accessible to the processor 104. It will be apparent to those of ordinary skill in the art that the methods and processes described herein can be implemented as software stored in main memory 106 or read only memory 108 and executed by the processor 104. This software may also be resident on an article of manufacture comprising a computer usable mass storage medium 112 having computer readable program code embodied therein and being readable by the mass storage device 110 and for causing the processor 104 to perform digital information library transactions and protocols in accordance with the teachings herein.

Typically, the server computer system includes detector software, server software and a database. The database is used to store questions as well as the responses entered by users as discussed below. Databases usable with the present system may be created using Microsoft Access or Oracle Database Software®.

Typically, the user's computer system is connected to the server computer system via the Internet or an intranet through a connection. The user's computer system also includes appropriate software to enable the user's computer system to communicate with the server computer system over the connection. Typically, the user's computer system will communicate with the server computer system over the Internet via an Internet browser such as Microsoft Internet Explorer or Netscape Navigator®.

The present invention can be implemented on a wide variety of hardware, including that shown in FIG. 2, or other suitable hardware configurations, such as network computers (NCs), systems that bring the World Wide Web to TV, or Personal Data Assistants such as Palm Pilots. Additionally, it will be understood by those skilled in the art, that the method of the present invention may be performed via software and databases on a stand alone computer rather than over a network such as the Internet.

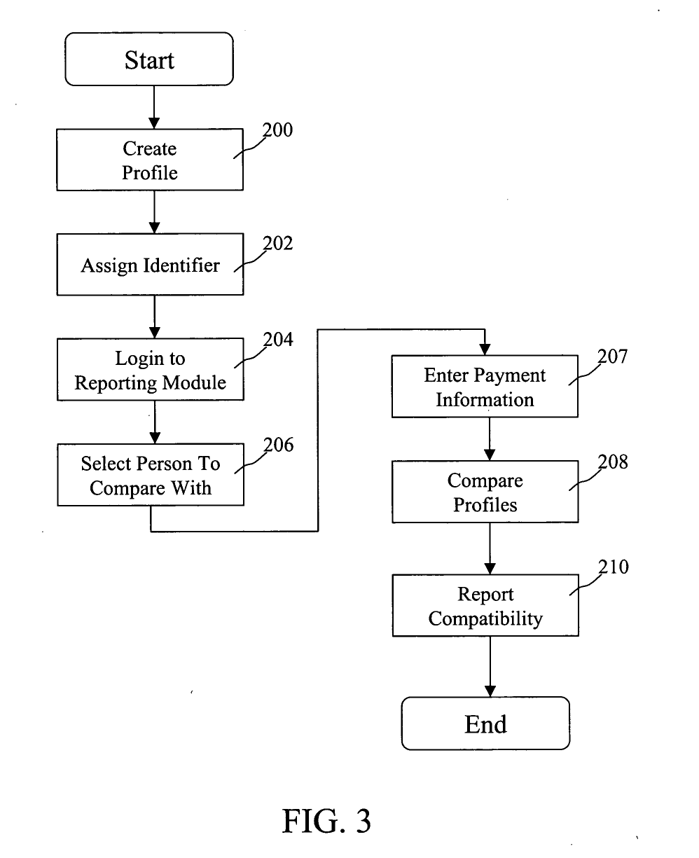

FIG. 3 is a flowchart showing general steps performed by a method of determining compatibility according to an embodiment of the present invention. A person access profile creation software and creates a profile in a profile creation step 200. The person is provided with a unique identification code in an identifier assignment step 202. The profile creation step 200 and the identifier assignment step 202 are repeated for one or more additional people.

Following profile creation by two or more people, one of the people (a “requester”) accesses reporting software and enters their unique identification code in a login step 204. Following the login step 204, the requester enters the unique identification code of another person with whom they would like to have their compatibility analyzed in a selection step 206. Once the code of another person is entered, the user is prompted to enter payment information, in a payment entry step 207. Once payment information has been successfully entered, the system compares the requestor's profile to the other person's profile in a comparison step 208. A report of compatibility is then provided to the requestor in a reporting step 210.

The profile creation step 200 will now,be considered in more detail. A person is prompted by the profile creation software to respond to a series of questions. The responses received from the person form a profile that is placed into a database for later comparison with the responses in a profile of another person.

In an embodiment of the present invention, the person is asked two different sets of questions. The questions are divided into two sets, because the person is prompted for different types of responses in each set. The questions can be asked in any order and the order presented here is for illustrative purposes only. Likewise, the questions asked of a person may be divided into additional sets with different types of responses.

Considering the first set of questions in more detail, the person is asked general questions about sexual orientation and attitudes. Some example questions of the first set of questions are shown in Table 1.

TABLE 1
First Set of Questions

| Topic | Options | Response |
|---|---|---|
| Gender | Male | |
| | Female | |
| Sexual Orientation | Heterosexual | |
| | Homosexual/Lesbian | |
| | Bisexual | |
| | Asexual (Platonic | |
| | Relationship Only) | |
| Relationship Style | Monogamous | |
| | Polygamous | |
| I Would Accept A Mate | Heterosexual | |
| Who Is: | | |
| | Homosexual | |
| | Bisexual | |
| | Transsexual | |
| | Asexual (Platonic | |
| | Only) | |
| Sexual Attitudes | Procreation | |
| | (Reproduction) Only | |
| | Recreational Only | |
| | Procreation and | |
| | Recreation | |
| | Neither (Platonic | |
| | Relationship Only) | |

As shown in Table 1, many of the questions in the first section prompt the person to select one of a given 5 number of options for each question. The number of options presented to the person depend upon the nature of the question. Additionally, some of the questions, such as “I would accept a mate who is:” allow the user to select multiple options.

Considering the second series of questions in more detail, the person is asked about relationship aspects, sexual activities, and sexual interests that are deemed important to the lasting success of a relationship. In an embodiment of the present invention, the person is given a range of preference levels to select from in response to each question. The responses include: “Must Have”, “Prefer”, “Interested”, “Not Interested” and “Must Not Have”.

The response choices listed here are illustrative in nature and may be replaced by fewer or greater choices. Additionally, other phrases may be used instead of the illustrated phrases. “Must Have” may be substituted with, for example, “must”, “need”, “required”, and “necessary”. “Prefer” may be substituted with, for example, “desire”, “inclined to”, and “want”. “Interested” may be substituted with, for example, “curious”, and “intrigued”. “Not interested” may be substituted with, for example, “no desire”, and “do not want”. “Must Not Have”, may be substituted with, for example, “would not tolerate”, “must not”, “absolutely not”, “definitely not”, “forbidden”, and “prohibited”.

Some example questions of the second set of questions are shown in Table 2.

TABLE 2
Second Set of Questions

| | | | | | Must |
|---|---|---|---|---|---|
| | Must | | | Not | Not |
| Question | Have | Prefer | Interested | Interested | Have |
| Sexually | | | | | |
| Explicit | | | | | |
| Language | | | | | |
| During Sex | | | | | |
| Fidelity | | | | | |
| Swinging | | | | | |
| Recreational | | | | | |
| Nudity | | | | | |
| Role | | | | | |
| Playing/ | | | | | |
| Fantasy | | | | | |
| Games | | | | | |

Questions in the first and second sections may be created by reference to the relationship information and the sexual information found in Sexual Behavior in the Human Male, Kinsey, Alfred C. et al. (1948/1998); Sexual Behavior in the Human Female, Kinsey, Alfred C. et al. (1953/1998); The Kinsey Data: Marginal Tabulations of 1938-1963 Interviews Conducted by the Institute for Sex Research, Gebhard, Paul H. and Johnson, Alan B. (1979/1998); and Masters and Johnsons on Sex and Human Loving; William H. Masters, Virginia E. Johnson, Robert C. Kolodny (1988); the entire contents of all of which are hereby incorporated herein by reference.

In an additional embodiment of the present invention, the responses to the second set of questions are selected from a numerical scale of seven choices ranging from one, corresponding to “must have” to seven, corresponding to “must not have”. The numerical responses allow for direct numerical comparison between two people.

Once all of the questions have been completed, the server issues the person a unique identification code and a unique password in the identifier assignment step 202. The unique identification code will be needed by other people to obtain compatibility information regarding the user as will be explained below. The unique password will be needed by the person to edit and change their responses at another time. The use of computer assigned identification codes and passwords allows for users of the system to maintain complete anonymity. The anonymity encourages people to be more candid in their responses to questions.

Typically, the unique identification code and the unique password will be randomly generated sets of 5 to 10 alphanumeric characters. Optionally, when a person attempts to gain access into the server to modify their profile at a different time, the person is prompted to create their own password. The person's password is then used if the person wants to edit and change their responses again at another time. Optionally, rather than the server generating the unique password, the person is prompted to enter a password.

Optionally, the person is prompted to enter an authorization list with the unique identification codes of other people whom the person will allow their profile to be compared against. The person can access their profile at a different time using their unique identifier and password to add to the authorization list. The use of an authorization list prevents unauthorized users from making comparisons, thereby enhancing privacy and encouraging more open responses to the questions asked during profile creation.

Once both people in a relationship have created profiles and obtained unique identifiers, then either person may obtain compatibility information from the reporting software. In order to maintain anonymity, a person who desires a report is sent to a payment server not associated with the reporting software to procure a payment code.

The payment server prompts the person to enter payment information. In an embodiment, the payment server prompts the person to enter credit card information, including, for example, billing name, billing address, billing telephone number, a credit card type, a credit card number, and an additional credit card code. Upon successful entry of credit card information, the payment server checks the information to determine whether the person has entered valid credit card information.

If the payment server determines that the person entered invalid information, then the payment server prompts the person to reenter information. If the payment server determines that the person has entered invalid information more than a predetermined number of times, then the person is forced to exit from the payment server. If the payment server determines that the person entered valid information, then the payment server issues the person a payment code. Typically, the payment code is a set of 5 to 10 alphanumeric characters.

A requestor accesses the reporting software and is prompted to enter their identification code and password in the login step 204. The system searches database records for the entered identification code and password. If the entered identification code is not found in the database, then the requester is prompted to enter another identification code. If the entered identification code is found, but the password does not correspond to the identification code, then the requester is prompted to enter another password. If the requester enters more than a predetermined number of incorrect identification codes or passwords, then the requestor is forced to exit from the reporting software.

Once the entered identification code and password are found in the database records, the system prompts the requestor to obtain a report comparing themselves to another person (a “comparison subject”) by entering a second identification code in the selection step 206. The system searches database records for the second identification code. If the second identification code is not found in the database, then the requester is prompted to enter another identification code. If the requester enters more than a predetermined number of incorrect second identification codes, then the requester is forced to exit from the reporting software.

In an embodiment where each person has an authorization list, the system checks to see if the requestor's unique identification code is listed in the comparison subject's authorization list. If the requestor's unique identification code is not found in the comparison subject's authorization list, then the requestor is forwarded a message such as “You have not been authorized to run this comparison. Please try back again later.” Once the message is sent, the requestor is disconnected from the network. If the requestor's identification code is found in the comparison subject's authorization list, then the system moves onto the next step.

The system then prompts the requestor to enter a payment code in the payment entry step 207. The use of a payment code allows for the requester to maintain anonymity. The reporting software validates the payment code entered by the user by contacting the payment server.

In an alternative embodiment, the payment code is self authenticating using a predetermined formula. If the payment code is self authenticating, then the reporting software stores used codes in memory so that they cannot be reused.

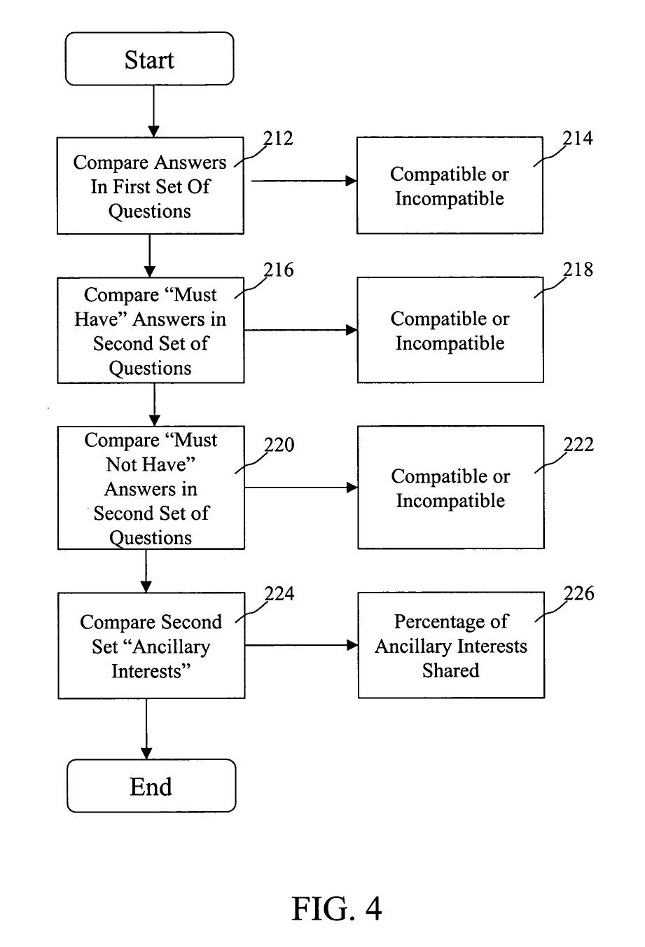

Once the payment code has been authenticated, the reporting software compares the responses in the requestor's profile with those of the comparison subject in the comparison step 208. FIG. 4 is a flowchart showing the comparison step 208 in more detail. The comparison methodology described is for illustrative purposes only and those skilled in the art will recognize that many different types of grading systems may be used.

Each set of questions is graded separately. The responses to the first set of questions are compared in step 212 using a chain elimination process to reach a decision of compatibility or incompatibility in step 214. Incompatibility is determined for those whose responses fall into categories that conflict. For example, if a requestor answers questions describing himself as a male heterosexual who would only accept a mate who is heterosexual, and the comparison subject answered questions indicating that they are a female bisexual who will accept mates who are both heterosexual and bisexual, then the comparison subject will be listed as incompatible with the requestor. Compatibility will be found if the responses of the comparison subject are complementary to the responses of the requestor. As used herein, “complementary”, means supplying the needs of.

As will be appreciated, although a requestor may be compatible with the needs and desires of a comparison subject, the needs and desires of the comparison subject may not be compatible with the needs and desires of the requester. In the above example, if the comparison subject was the requester, then compatibility would be found.

In an alternative embodiment of the present invention, the responses to the first set of questions are graded from the perspective of both the requester and the comparison subject. This would report incompatibility to both users, even if one of the two people may be compatible with the other. In this embodiment, the responses of both the requestor and the comparison subject must be complementary to each other for a determination of compatibility to be made.

Considering the responses to the second set of questions, if the requestor answered any questions with “Must Have” or “Must Not Have”, then these question are scored in a “Key Match” dataset. First, the questions answered “Must Have” by the requester are considered in step 216 to reach a decision of compatibility or incompatibility in step 218. For purposes of example, a determination of compatibility is labeled as a “Key Match”, although other labels may be used. If the requestor selected “Must Have”, then the comparison subject must have answered either “Must Have” or “Preferred” to be a Key Match.

Next, the questions answered “Must Not Have” by the requestor are considered in step 220 to reach a decision of compatibility or incompatibility in step 222. If the requester selected “Must Not Have”, then the comparison subject must have checked either “Must Not Have” or “Not Interested” to be a Key Match.

Those questions in the second set that a requestor answered with an answer other than “Must Have” or “Must Not Have”, are considered to be “ancillary interests”. Questions considered to be “ancillary interests” are scored in step 224 to determine a percentage of shared “ancillary interests” in step 226 as follows.

If the requestor answered “Preferred” and the comparison subject answered “Preferred or Must Have”, then 100 points is assigned to the question. If the requestor answered “Preferred” and the comparison subject answered “Interested”, then 50 points is assigned to the question. If the requestor answered “Preferred” and the comparison subject answered “Not Interested” or “Must Not Have” , then 0 points is assigned to the question.

If the requestor answered “Interested” and the comparison subject answered either “Interested” or “Preferred, then 50 points is assigned to the question. If the requester answered “Not Interested” and the comparison subject answered “Not Interested” or “Must not Have”, then 100 points is assigned to the question. If the requestor answered “Not Interested” and the comparison subject answered “Preferred” or “Must Have”, then 0 points is assigned to the question.

If the requestor answered the question with an answer making that question an ancillary interest and the comparison subject party answered that same question with either “Must Have” or “Must Not Have”, then that question will be graded as a Key Match question if the comparison subject compares themselves to the requesting party. Therefore, when the comparison subject acts as the requestor, that same questions is evaluated in the Key Match framework described above. In an additional embodiment of the present invention, a question is evaluated in the Key Match framework if either the requestor or the comparison subject answered the question as “Must Have” or “Must Not Have”.

The total number of points is divided by the total number of question scored as ancillary interests to determine a percentage of matching ancillary interests. Those skilled in the art will recognize that the grading may be conducted using other statistical analysis methods known in the art.

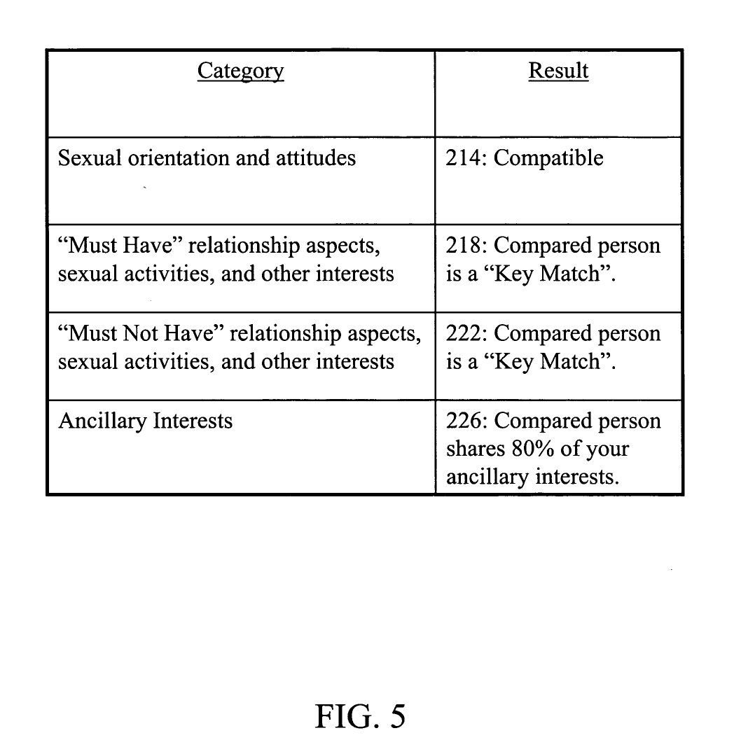

Once the comparison is complete, a report is provided to the requestor's computer where it can be viewed and/or printed in the reporting step 210. In an embodiment, the report provides multiple separate comparison results to the requester. However, the report does not reveal requester or comparison subject answers to any specific questions used in determining compatibility. A sample report is shown in FIG. 5.

First, the report provides comparison results for the first set of questions as found in step 214 of the comparison. The results for the first set of questions indicate whether the two people have compatible sexual orientation and attitudes and is usually reported as either “compatible” or “not compatible”. Other phrasing may be used such as “match” or “no match”.

The report provides three different comparison results for the second set of questions. The report provides a first comparison result for those questions that the requestor answered as “Must Have”, as found in step 218 of the comparison. The report provides a second comparison result for those questions that the requester answered as “Must Not Have”, as found in step 222 of the comparison.

For those questions answered “Must Have”, by the report requester, the report designates the other party as a “Key Match” if they answered all of those questions as either “Must Have” or “Preferred”. If for any of the questions answered “Must Have” by the requester, the other party answered “Interested”, “Not Interested”, or “Must Not Have”, then the other party is reported as “Not a Key Match”. Equivalent phrasing may be used in this section of the report, such as “compatible” or “not compatible”. optionally, if the other party answered “Interested” to a “Must Have” question then an additional statement such as “however, the differences may be resolvable through further discussion and exploration” may be added.

For those questions answered “Must Not Have” by the report requester, the report designates the other party as a “Key Match” if they answered all of those questions as either “Must Not Have” or “Not Interested”. If for any of the questions answered “Must Not Have” by the requester, the other party answered “Interested”, “Preferred” , or “Must Have”, then the other party is reported as “Not a Key Match.”Equivalent phrasing may be used in this section of the report such as “compatible” or “not compatible”.

The report provides a third comparison result for those questions answered by the requestor as “Preferred”, “Interested”, or “Not Interested”, such questions being considered as “ancillary interests”, as found in step 226 of the comparison. The report provides the percentage of “ancillary interest” similarity, which is obtained as discussed above.

Although the present invention has been described in considerable detail with reference to certain preferred versions thereof, other versions are possible. Therefore, the spirit and scope of the appended claims should not be limited to the description of the preferred versions described herein.

All features disclosed in the specification, including the claims, abstracts and drawings, and all the steps in any method or process disclosed, may be combined in any combination except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function, should not be interpreted as a “means” or “step” clause as specified in 35 U.S.C. §112.

1. A computerized method for determining compatibility between two people, the method comprising the steps of:
a) asking a first person a plurality of questions;
b) receiving from the first person responses to at least some of the questions;
c) asking a second person the plurality of questions;
d) receiving from the second person responses to at least some of the questions;
e) comparing the responses received from the first person and the responses received from the second person to determine the compatibility of the first person and the second person; and
f) reporting the results of step (e) to at least one of the persons without revealing at least one of the compared responses received.

2. The method of claim 1 wherein none of the compared responses are revealed.

3. The method of claim 1 wherein the plurality of questions comprises a first set of questions about at least one of sexual attitudes, tolerances and lifestyle.

4. The method of claim 3 wherein the responses of the first person and the responses of the second person to the first set of questions must be complementary for compatibility.

5. The method of claim 4 wherein the plurality of questions further comprises a second set of questions about at least one of relationship aspects, sexual activities, and sexual interests and wherein the user is prompted to select from a range of preference levels.

6. The method of claim 5 wherein the preference levels further comprise at least three discrete preference levels.

7. The method of claim 6 wherein the preference levels further comprise five discrete preference levels substantially corresponding to “must have”, “preferred”, “interested”, “not interested”, and “must not have”.

8. The method of claim 7 wherein all of the questions responded to by the first person as “must have”, must be responded to by the second person as “must have” or “preferred” for compatibility.

9. The method of claim 8 wherein all of the questions responded to by the second person as “must have”, must be responded to by the first person as “must have” or “preferred” for compatibility.

10. The method of claim 7 wherein all of the questions responded to by the first person as “must not have”, must be responded to by the second person as “must not have” or “not interested” for compatibility.

11. The method of claim 10 wherein all of the questions responded to by the second person as “must not have”, must be responded to by the first person as “must not have” or “not interested” for compatibility.

12. The method of claim 7 wherein all of the questions responded to by one of the first person or the second person as “preferred”, “interested”, and “not interested” are compared to the responses of the other person to obtain a percentage of similarity.

13. The method of claim 6 wherein the preference levels further comprise seven numerical preference levels from “must have” to “must not have”.

14. The method of claim 1 further comprising:
g) providing the first person with a first unique identification code;
h) providing the second person with a second unique identification code; and
i) prompting one of the first person and the second person to enter the first unique identification code and the second identification code.

15. A system for determining compatibility between two people comprising:
at least one software interface for entering a first profile for a first user and a second profile for a second user, each of the first profile and the second profile containing responses to a plurality of questions;
at least one database for storing the first profile and the second profile; and
a software program for comparing the profile of the first user and the profile of the second user, and for reporting the compatibility of the first user and the second user without revealing the responses contained in the first profile or the second profile.

16. The system of claim 15 wherein each of the first profile and the second comprise responses to a plurality of questions about at least one of sexual attitudes, tolerances and lifestyle.

17. The system of claim 16 wherein the responses of the first person and the responses of the second person to the plurality of questions must be complementary for compatibility.

18. The system of claim 15 wherein each of the first profile and the second profile comprise responses to a plurality of questions about at least one of relationship aspects, sexual activities, and sexual interests; and wherein the user is prompted to select from a range of preference levels.

19. The system of claim 18 wherein the preference levels further comprise at least five discreet preference levels substantially corresponding to “must have”, “preferred”, “interested”, “not interested”, and “must not have”.

20. The system of claim 19 wherein all of the questions responded to by the first person as “must have”, must be responded to by the second person as “must have” or “preferred” for compatibility.

21. The system of claim 20 wherein all of the questions responded to by the second person as “must have”, must be responded to by the first person as “must have” or “preferred” for compatibility.

22. The system of claim 19 wherein all of the questions responded to by the first person as “must not have”, must be responded to by the second person as “must not have” or “not interested” for compatibility.

23. The system of claim 22 wherein all of the questions responded to by the second person as “must not have”, must be responded to by the first person as “must not have” or “not interested” for compatibility.

24. The system of claim 19 wherein all of the questions responded to by one of the first person or the second person as “preferred”, “interested”, and “not interested” are compared to the responses of the other person to obtain a percentage of similarity.

25. An online compatibility determining method comprising the steps of:
prompting a first user to enter a first profile and a second user to enter a second profile, each profile containing responses to a plurality of questions;
receiving from the first user a request to compare the first profile with the second profile. comparing the first profile and the second profile to determine compatibility; and
reporting compatibility information to the first user without revealing the contents of either the first profile or the second profile.

26. The online compatibility determining method of claim 25 wherein:
the profiles comprising responses to a first set of questions about at least one of sexual attitudes, tolerances and lifestyle, and responses to a second set of questions about at least one of relationship aspects, sexual activities, and sexual interests on a range of preference levels;
the second person's responses to the first set of questions must be complementary to the first person's for compatibility;
the preference levels further comprise at least five discreet preference levels substantially corresponding to “must have”, “preferred”, “interested”, “not interested”, and “must not have”;
those questions responded to by one of the first person or the second person as “must have”, must be responded to by the other person as “must have” or “preferred” for compatibility;
those questions responded to by one of the first person or the second person as “must not have”, must be responded to by the other person as “must not have” or “not interested” for compatibility; and
those questions responded to by one of the first person or the second person as “preferred”, “interested”, and “not interested” are compared to the responses of the other person to obtain a percentage of similarity.
